(19) United States
(12) Patent Application Publication
(10) Pub. No.: US 2005/0084709 A1
(43) Pub. Date: Apr. 21, 2005

(54) Organic electroluminescent device

(76) Inventors: Yuji Hamada, Ikoma-gun (JP); Masakazu Sakata, Osaka (JP)

Correspondence Address: MCDERMOTT, WILL & EMERY, 600 13th Street, N.W., Washington, DC, 20005-3096, US

(21) Appl. No.: 10/813,624

(22) Filed: Mar. 31, 2004

(30) Foreign Application Priority Data
Mar. 31, 2003 (JP) 2003-097307

(51) Int. Cl. H05B 33/12

(52) U.S. Cl. 428/690; 428/917; 313/504; 313/506

(57) ABSTRACT

In an organic EL device whose any layer of organic compound layers contains a phenylamine derivative (NPB, for instance), the weight concentration of copper atoms contained in the organic compound layer is controlled to not higher than 500 ppm, the weight concentration of aluminum atoms contained in the organic compound layer is controlled to not higher than 800 ppm, and the weight concentration of iron atoms contained in the organic compound layer is controlled to not higher than 800 ppm. Furthermore, the weight concentration of nickel atoms contained in the organic compound layer is controlled to not higher than 900 ppm, and the weight concentration of sodium atoms contained in the organic compound layer is controlled to not higher than 1000 ppm.

### BACKGROUND OF THE INVENTION

1. Field of the Invention

The present invention relates to an organic electroluminescent device.

2. Description of the Background Art

In recent years, with increasing diversity in information equipment, there is a growing need for flat panel display devices that require smaller power consumption than CRTs (Cathode Ray Tube) generally in use. As one of the flat panel display devices, an organic electroluminescent (hereinafter abbreviated as organic EL) device characterized by having high efficiency, small thickness, light weight, and low angular-field-of-view dependency is drawing attention, and the development of displays using the organic EL device is proceeding.

An organic EL device is a self light emitting device, in which electrons and holes are injected into a light emitting portion from an electron injection electrode and a hole injection electrode, respectively, and the injected electrons and holes are recombined at the light emitting center to bring an organic molecule into an excited state, so that the organic molecule emits fluorescent light when returning to a ground state from the excited state.

An emission color of the organic EL device can be varied by the selection of a fluorescent substance as a luminescent material, and therefore, the organic EL device is expected to find applications in such displays as multi-color and full-color displays. The organic EL device can also serve as the backlight for a liquid crystal display and the like because of the capability of surface-light emission at low voltage. Such organic EL devices are currently in the development stage for applications in small displays used in digital cameras, portable telephones, and the like.

In general, an organic EL device has a structure in which a hole injection electrode, a hole injection layer, a hole transport layer, a light emitting layer, an electron transport layer, an electron injection layer, and an electron injection electrode are layered in this order. The hole injection layer, hole transport layer, light emitting layer, electron transport layer, and electron injection layer will, hereinafter, be called organic compound layers.

A phenylamine derivative having high hole transport capability is employed for the hole injection layer and hole transport layer in an organic EL device (refer to, for instance, JP-14-237384-A). By employing a phenylamine derivative, holes are efficiently transported in the hole injection layer and hole transport layer.

In the organic compound layers forming an organic EL device, various impurities are considered to be involved with the luminescent characteristics. That is, some impurities are considered to improve the luminescent characteristics, while others may deteriorate the luminescent characteristics.

However, it has not been clarified in detail, how particular impurities in the organic compound layers may affect the luminescent characteristics.

### SUMMARY OF THE INVENTION

An object of the present invention is to provide an organic EL device having improved luminous efficiency and luminescent lifetime by controlling particular impurities in an organic compound layer.

As a result of wholehearted experiment and examination by the inventors in order to clarify how impurities in an organic compound layer may affect luminescent characteristics, it was found out that particular metal impurities in the organic compound layer causes significant deterioration in carrier transport capability, leading to deteriorated luminescent characteristics. Furthermore, the inventors made findings that the luminescent characteristics can be improved by controlling the concentration of the particular metal impurities in the organic compound layer, thereby conceiving a following invention.

An organic electroluminescent device according to one aspect of the present invention comprises an organic compound layer containing an organic compound having a phenylamino group, and the organic compound layer contains copper atoms having a weight concentration of not higher than 500 ppm as impurities.

The phenylamino group is expressed by the following formula (1):

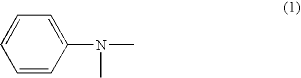

The weight concentration of copper atoms as impurities in the organic compound layer is not higher than 500 ppm, so that the transport capability of carriers injected into the organic compound layer is improved. This can prevent deterioration in the recombination of carriers. As a result, the luminous efficiency and luminescent lifetime of the light emitting layer can be improved.

The weight concentration of copper atoms as impurities in the organic compound layer may be not higher than 200 ppm. The weight concentration of copper atoms as impurities in the organic compound layer is not higher than 200 ppm, so that the transport capability of carriers injected into the organic compound layer is improved. This can prevent deterioration in the recombination of carriers. As a result, the luminous efficiency and luminescent lifetime of the light emitting layer can be improved.

The organic compound layer may include an organic compound film containing a luminescent material, and an organic compound film containing a carrier transporting material.

An organic electroluminescent device according to another aspect of the present invention comprises an organic compound layer containing an organic compound having a phenylamino group, and the organic compound layer contains aluminum atoms having a weight concentration of not higher than 800 ppm as impurities.

The weight concentration of aluminum atoms as impurities in the organic compound layer is not higher than 800 ppm, so that the transport capability of carriers injected into the organic compound layer is improved. This can prevent deterioration in the recombination of carriers. As a result, the luminous efficiency and luminescent lifetime of the light emitting layer can be improved.

The organic compound layer may include an organic compound film containing a luminescent material, and an organic compound film containing a carrier transporting material.

An organic electroluminescent device according to still another aspect of the present invention comprises an organic compound layer containing an organic compound having a phenylamino group, and the organic compound layer contains iron atoms having a weight concentration of not higher than 800 ppm as impurities.

The weight concentration of iron atoms as impurities in the organic compound layer is not higher than 800 ppm, so that the transport capability of carriers injected into the organic compound layer is improved. This can prevent deterioration in the recombination of carriers. As a result, the luminous efficiency and luminescent lifetime of the light emitting layer can be improved.

The organic compound layer may include an organic compound film containing a luminescent material, and an organic compound film containing a carrier transporting material.

An organic electroluminescent device according to still another aspect of the present invention comprises an organic compound layer containing an organic compound having a phenylamino group, and the organic compound layer contains nickel atoms having a weight concentration of not higher than 900 ppm as impurities.

The weight concentration of nickel atoms as impurities in the organic compound layer is not higher than 900 ppm, so that the transport capability of carriers injected into the organic compound layer is improved. This can prevent deterioration in the recombination of carriers. As a result, the luminous efficiency and luminescent lifetime of the light emitting layer can be improved.

The organic compound layer may include an organic compound film containing a luminescent material, and an organic compound film containing a carrier transporting material.

An organic electroluminescent device according to still another aspect of the present invention comprises an organic compound layer containing an organic compound having a phenylamino group, and the organic compound layer contains sodium atoms having a weight concentration of not higher than 1000 ppm as impurities.

The weight concentration of sodium atoms as impurities in the organic compound layer is not higher than 1000 ppm, so that the transport capability of carriers injected into the organic compound layer is improved. This can prevent deterioration in the recombination of carriers. As a result, the luminous efficiency and luminescent lifetime of the light emitting layer can be improved.

The organic compound layer may include an organic compound film containing a luminescent material, and an organic compound film containing a carrier transporting material.

An organic electroluminescent device according to still another aspect of the present invention comprises a plurality of organic compound films, and at least one of the plurality of organic compound films includes an organic compound having a phenylamine group, and when the weight of at least one organic compound film is not lower than 30% of a sum of the weights of the plurality of organic compound films, the weight concentration of copper atoms as impurities in the at least one organic compound film is not higher than 170 ppm.

The weight concentration of copper atoms as impurities in the at least one organic compound film is not higher than 170 ppm, so that the transport capability of carriers injected into the organic compound film is improved. This can prevent deterioration in the recombination of carriers. As a result; the luminous efficiency and luminescent lifetime of the light emitting layer can be improved.

The weight concentration of copper atoms as impurities in the at least one organic compound film is preferably not higher than 70 ppm.

The weight concentration of copper atoms as impurities in the at least one organic compound film is not higher than 70 ppm, so that the transport capability of carriers injected into the organic compound film is improved. This can prevent deterioration in the recombination of carriers. As a result, the luminous efficiency and luminescent lifetime of the light emitting layer can be improved.

An organic electroluminescent device according to still another aspect of the present invention comprises a plurality of organic compound films, and at least one of the plurality of organic compound films includes an organic compound having a phenylamino group, and when the weight of at least one organic compound film is not lower than 30% of a sum of the weights of the plurality of organic compound films, the weight concentration of aluminum atoms as impurities in the at least one organic compound film is not higher than 270 ppm.

The weight concentration of aluminum atoms as impurities in the at least one organic compound film is not higher than 270 ppm, so that the transport capability of carriers injected into the organic compound film is improved. This can prevent deterioration in the recombination of carriers. As a result, the luminous efficiency and luminescent lifetime of the light emitting layer can be improved.

An organic electroluminescent device according to still another aspect of the present invention comprises a plurality of organic compound films, and at least one of the plurality of organic compound films includes an organic compound having a phenylamino group, and when the weight of at least one organic compound film is not lower than 30% of a sum of the weights of the plurality of organic compound films, the weight concentration of iron atoms as impurities in the at least one organic compound film is not higher than 270 ppm.

The weight concentration of iron atoms as impurities in the at least one organic compound film is not higher than 270 ppm, so that the transport capability of carriers injected into the organic compound film is improved. This can prevent deterioration in the recombination of carriers. As a result, the luminous efficiency and luminescent lifetime of the light emitting layer can be improved.

An organic electroluminescent device according to still another aspect of the present invention comprises a plurality of organic compound films, and at least one of the plurality of organic compound films includes an organic compound having a phenylamino group, and when the weight of at least one organic compound film is not lower than 30% of a sum of the weights of the plurality of organic compound films, the weight concentration of nickel atoms as impurities in the at least one organic compound film is not higher than 300 ppm.

The weight concentration of nickel atoms as impurities in the at least one organic compound film is not higher than 300 ppm, so that the transport capability of carriers injected into the organic compound film is improved. This can prevent deterioration in the recombination of carriers. As a result, the luminous efficiency and luminescent lifetime of the light emitting layer can be improved.

An organic electroluminescent device according to still another aspect of the present invention comprises a plurality of organic compound films, and at least one of the plurality of organic compound films includes an organic compound having a phenylamino group, and when the weight of at least one organic compound film is not lower than 30% of a sum of the weights of the plurality of organic compound films, the weight concentration of sodium atoms as impurities in the at least one organic compound film is not higher than 340 ppm.

The weight concentration of sodium atoms as impurities in the at least one organic compound film is not higher than 340 ppm, so that the transport capability of carriers injected into the organic compound film is improved. This can prevent deterioration in the recombination of carriers. As a result, the luminous efficiency and luminescent lifetime of the light emitting layer can be improved.

An organic electroluminescent device according to still another aspect of the present invention comprises an organic compound layer containing an organic compound having a quinolinol group, and the organic compound layer contains iron atoms having a weight concentration of not higher than 800 ppm as impurities.

The quinolinol group is expressed by the following formula (2):

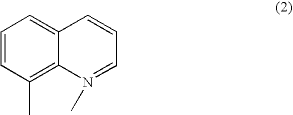

The weight concentration of iron atoms as impurities in the organic compound layer is not higher than 800 ppm, so that the transport capability of carriers injected into the organic compound layer is improved. This can prevent deterioration in the recombination of carriers. As a result, the luminous efficiency and luminescent lifetime of the light emitting layer can be improved.

The organic compound layer may include an organic compound film containing a luminescent material, and an organic compound film containing a carrier transporting material.

An organic electroluminescent device according to still another aspect of the present invention comprises an organic compound layer containing an organic compound having a quinolinol group, and the organic compound layer contains nickel atoms having a weight concentration of not higher than 900 ppm as impurities.

The weight concentration of nickel atoms as impurities in the organic compound layer is not higher than 900 ppm, so that the transport capability of carriers injected into the organic compound layer is improved. This can prevent deterioration in the recombination of carriers. As a result, the luminous efficiency and luminescent lifetime of the light emitting layer can be improved.

The organic compound layer may include an organic compound film containing a luminescent material, and an organic compound film containing a carrier transporting material.

An organic electroluminescent device according to still another aspect of the present invention comprises an organic compound layer containing an organic compound having a quinolinol group, and the organic compound layer contains sodium atoms having a weight concentration of not higher than 1000 ppm as impurities.

The weight concentration of sodium atoms as impurities in the organic compound layer is not higher than 1000 ppm, so that the transport capability of carriers injected into the organic compound layer is improved. This can prevent deterioration in the recombination of carriers. As a result, the luminous efficiency and luminescent lifetime of the light emitting layer can be improved.

The organic compound layer may include an organic compound film containing a luminescent material, and an organic compound film containing a carrier transporting material.

An organic electroluminescent device according to still another aspect of the present invention comprises a plurality of organic compound films, and at least one of the plurality of organic compound films includes an organic compound having a quinolinol group, and when the weight of at least one organic compound film is not lower than 30% of a sum of the weights of the plurality of organic compound films, the weight concentration of iron atoms as impurities in the at least one organic compound film is not higher than 270 ppm.

The weight concentration of iron atoms as impurities in the at least one organic compound film is not higher than 270 ppm, so that the transport capability of carriers injected into the organic compound film is improved. This can prevent deterioration in the recombination of carriers. As a result, the luminous efficiency and luminescent lifetime of the light emitting layer can be improved.

An organic electroluminescent device according to still another aspect of the present invention comprises a plurality of organic compound films, and at least one of the plurality of organic compound films includes an organic compound having a quinolinol group, and when the weight of at least one organic compound film is not lower than 30% of a sum of the weights of the plurality of organic compound films, the weight concentration of nickel atoms as impurities in the at least one organic compound film is not higher than 300 ppm.

The weight concentration of nickel atoms as impurities in the at least one organic compound film is not higher than 300 ppm, so that the transport capability of carriers injected into the organic compound film is improved. This can prevent deterioration in the recombination of carriers. As a result, the luminous efficiency and luminescent lifetime of the light emitting layer can be improved.

An organic electroluminescent device according to still another aspect of the present invention comprises a plurality of organic compound films, and at least one of the plurality of organic compound films includes an organic compound having a quinolinol group, and when the weight of at least one organic compound film is not lower than 30% of a sum of the weights of the plurality of organic compound films, the weight concentration of sodium atoms as impurities in the at least one organic compound film is not higher than 340 ppm.

The weight concentration of sodium atoms as impurities in the at least one organic compound film is not higher than 340 ppm, so that the transport capability of carriers injected into the organic compound film is improved. This can prevent deterioration in the recombination of carriers. As a result, the luminous efficiency and luminescent lifetime of the light emitting layer can be improved.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram showing the structure of an organic EL device according to an embodiment of the present invention;

FIG. 2 is a graph showing the results of luminous efficiencies in relation to the weight concentrations of aluminum atoms contained in the hole transport layers 4;

FIG. 3 is a graph showing the results of luminous efficiencies in relation to the weight concentrations of sodium atoms contained in the hole transport layers 4;

FIG. 4 is a graph showing the results of luminous efficiencies in relation to the weight concentrations of iron atoms contained in the hole transport layers 4;

FIG. 5 is a graph showing the results of luminous efficiencies in relation to the weight concentrations of nickel atoms contained in the hole transport layers 4;

FIG. 6 is a graph showing the results of luminous efficiencies in relation t- the weight concentrations of sodium atoms contained in the light emitting layers 5;

FIG. 7 is a graph showing the results of luminous efficiencies in relation to the weight concentrations of iron atoms contained in the light emitting layers 5; and

FIG. 8 is a graph showing the results of luminous efficiencies in relation to the weight concentrations of nickel atoms contained in the light emitting layers 5.

### DESCRIPTION OF THE PREFERRED EMBODIMENTS

Description will, hereinafter, be made of an organic electroluminescent (hereinafter abbreviated as an organic EL) device according to an embodiment of the present invention with reference to the drawings.

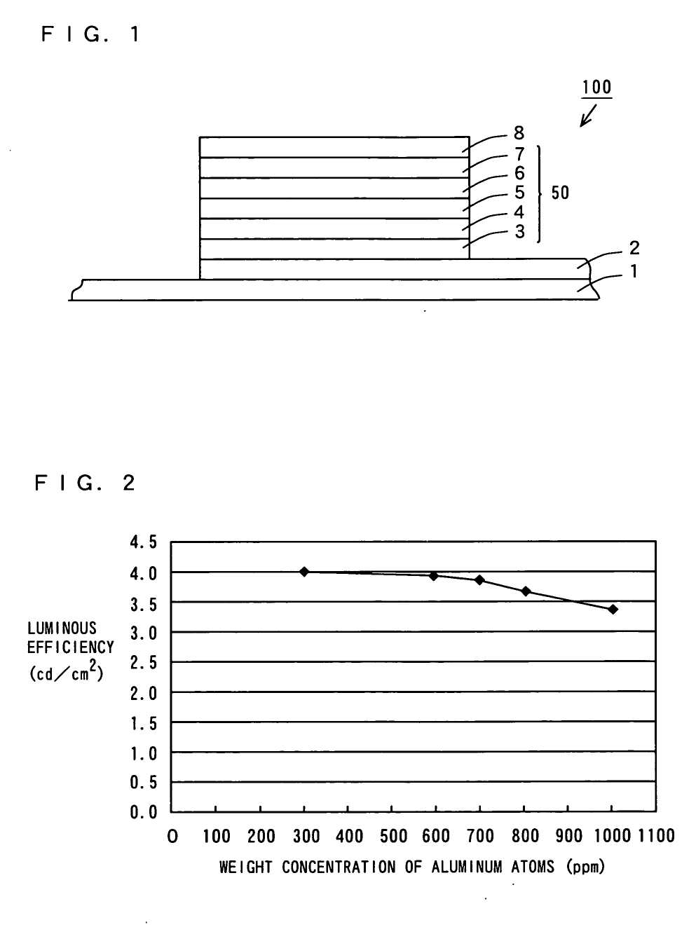

FIG. 1 is a schematic diagram showing the structure of an organic EL device according to an embodiment of the present invention.

As shown in FIG. 1, in an organic EL device 100, a hole injection electrode (anode) 2 composed of a transparent electrode film is formed on a glass substrate 1. On the hole injection electrode 2, a hole injection layer 3 composed of an organic material, a hole transport layer 4 composed of an organic material, and a light emitting layer 5 composed of an organic material are formed in this order. On the light emitting layer 5, an electron transport layer 6 composed of an organic material is formed, and on the electron transport layer 6, an electron injection layer 7 composed of an organic material is formed. Further, on the electron injection layer 7, an electron injection electrode (cathode) 8 is formed. The hole injection layer 3, hole transport layer 4, light emitting layer 5, electron transport layer 6, and electron injection layer 7 form an organic compound layer 50. In this case, the hole injection layer 3, hole transport layer 4, light emitting layer 5, electron transport layer 6, and electron injection layer 7 correspond to a plurality of organic compound films.

The hole injection layer 3, hole transport layer 4, light emitting layer 5, electron transport layer 6, and electron injection layer 7 are each composed of an organic compound. Note that the electron injection layer 7 may be composed of an inorganic material, such as lithium fluoride (LiF). In that case, the hole injection layer 3, hole transport layer 4, light emitting layer 5, and electron transport layer 6 form the organic compound layer 50.

In the present embodiment, N,N′-Di(naphthalene-1-yl)-N,N′-diphenyl-benzidine (hereinafter referred to as NPB) which is a kind of phenylamine derivatives and has a molecular structure expressed by the following formula (1) is employed as an organic compound. Phenylamine derivatives are produced by the Ullmann reaction. In the Ullmann reaction, copper powder is employed as a catalyst.

Also, as an organic compound, Tris(8-hydroxyquinolinato)aluminum (hereinafter refereed to as Alq) which is a kind of quinoline derivatives and has a molecular structure expressed by the following formula (2) is employed.

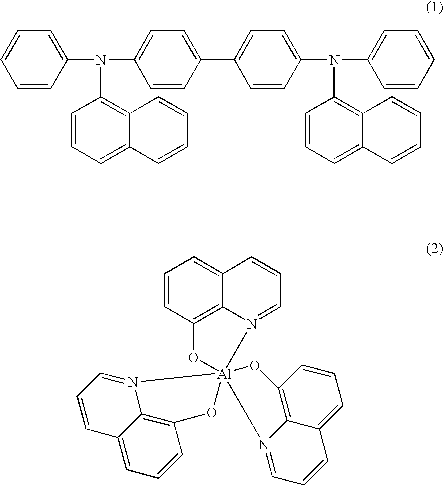

The hole injection electrode 2 is a transparent electrode, a semi-transparent electrode, or an non-transparent electrode made of a metal compound such as ITO (Indium-Tin Oxide), a metal such as silver, or an alloy. In addition, the electron injection electrode 8 is a transparent electrode made of a metal compound such as ITO, a metal, or an alloy.

When a drive voltage is applied between the hole injection electrode 2 and the electron injection electrode 8 in the organic EL device 100, the light emitting layer 5 emits light. The light produced in the light emitting layer 5 is emitted outside through the electron injection electrode 8 and a color filter (not shown) or the like.

Description will now be made of a method for measuring the content of metal atoms contained in the organic compound layer 50 according to the present embodiment.

In the present embodiment, because each of the layers forming the organic compound layer 50 has a very small thickness with low strength, it is difficult to separate each of the layers in the organic compound layer 50 to conduct measurements of the content of the metal atoms.

For this reason, the organic compound layer 50 is separated from the glass substrate 1 by dissolving the organic EL device in a solvent.

The above-mentioned solvent is subsequently evaporated, so that the organic compounds forming the organic compound layer 50 dissolved in the solvent are solidified.

The solidified organic compounds are then weighed, and heated in a crucible to be incinerated. After that, an acid, such as a hydrochloric acid, is added to the incinerated organic compounds, so that the metal contained in the organic compounds is dissolved. The test sample thus obtained by adding the acid to the organic compounds and dissolving the metal therein is subsequently diluted in pure water to a certain level, to measure the weight concentration of metal atoms contained in the organic compounds using ICP (Inductively Coupled Plasma) method.

In the ICP method, a sample containing metal atoms is placed in a high-temperature argon plasma, and the light produced from the sample is measured. Since the light has a wavelength peculiar to metal atoms and has intensity proportional to an amount of the metal atoms in the sample, quantitative analysis of weight concentration of the metal atoms contained in the sample is allowed.

While in the present embodiment the ICP method is used for the measurement of weight concentration of metal atoms, other methods, such as atomic absorption method, may also be used for the measurement.

In the organic EL device 100 whose any layer of the organic compound layer 50 contains a phenylamine derivative (NPB, for instance), the weight concentration of copper atoms contained in the organic compound layer 50 as impurities is preferably 500 ppm or lower. This enhances the luminous efficiency and luminescent lifetime of the light emitting layer 5.

The weight concentration of copper atoms contained in the organic layers 50 as impurities is more preferably 200 ppm or lower. This further enhances the luminous efficiency and luminescent lifetime of the light emitting layer 5.

Moreover, in the organic EL device 100 whose any layer of the organic compound layer 50 contains a phenylamine derivative (NPB, for instance), the weight concentration of aluminum atoms contained in the organic layers 50 as impurities is preferably 800 ppm or lower. This enhances the luminous efficiency and luminescent lifetime of the light emitting layer 5.

Moreover, in the organic EL device 100 whose any layer of the organic compound layer 50 contains a phenylamine derivative (NPB, for instance), the weight concentration of iron atoms contained in the organic layers 50 as impurities is preferably 800 ppm or lower. This enhances the luminous efficiency and luminescent lifetime of the light emitting layer 5.

Moreover, in the organic EL device 100 whose any layer of the organic compound layer 50 contains a phenylamine derivative (NPB, for instance), the weight concentration of nickel atoms contained in the organic layers 50 as impurities is preferably 900 ppm or lower. This enhances the luminous efficiency and luminescent lifetime of the light emitting layer 5.

Moreover, in the organic EL device 100 whose any layer of the organic compound layer 50 contains a phenylamine derivative (NPB, for instance), the weight concentration of sodium atoms contained in the organic layers 50 as impurities is preferably 1000 ppm or lower. This enhances the luminous efficiency and luminescent lifetime of the light emitting layer 5.

In the organic EL device 100 whose any layer of the organic compound layer 50 contains a quinoline derivative (Alq, for instance), the weight concentration of iron atoms contained in the organic layers 50 as impurities is preferably 800 ppm or lower. This enhances the luminous efficiency and luminescent lifetime of the light emitting layer 5.

Moreover, in the organic EL device 100 whose any layer of the organic compound layer 50 contains a quinoline derivative (Alq, for instance), the weight concentration of nickel atoms contained in the organic layers 50 as impurities is preferably 900 ppm or lower. This enhances the luminous efficiency and luminescent lifetime of the light emitting layer 5.

Moreover, in the organic EL device 100 whose any layer of the organic compound layer 50 contains a quinoline derivative (Alq, for instance), the weight concentration of sodium atoms contained in the organic layers 50 as impurities is preferably 1000 ppm or lower. This enhances the luminous efficiency and luminescent lifetime of the light emitting layer 5.

In the organic EL device 100 whose any layer of the organic compound layer 50 contains a phenylamine derivative (NPB, for instance) and a quinoline derivative (Alq, for instance), the weight concentration of copper atoms contained in the organic layers 50 as impurities is preferably 500 ppm or lower. This enhances the luminous efficiency and luminescent lifetime of the light emitting layer 5.

The weight concentration of copper atoms contained in the organic layers 50 as impurities is more preferably 200 ppm or lower. This further enhances the luminous efficiency and luminescent lifetime of the light emitting layer 5.

Moreover, in the organic EL device 100 whose any layer of the organic compound layer 50 contains a phenylamine derivative (NPB, for instance) and a quinoline derivative (Alq, for instance), the weight concentration of aluminum atoms contained in the organic layers 50 as impurities is preferably 800 ppm or lower. This enhances the luminous efficiency and luminescent lifetime of the light emitting layer 5.

Moreover, in the organic EL device 100 whose any layer of the organic compound layer 50 contains a phenylamine derivative (NPB, for instance) and aquinoline derivative (Alq, for instance), the weight concentration of iron atoms contained in the organic layers 50 as impurities is preferably 1600 ppm or lower. This enhances the luminous efficiency and luminescent lifetime of the light emitting layer 5.

Moreover, in the organic EL device 100 whose any layer of the organic compound layer 50 contains a phenylamine derivative (NPB, for instance) and a quinoline derivative (Alq, for instance), the weight concentration of nickel atoms contained in the organic layers 50 as impurities is preferably 1800 ppm or lower. This enhances the luminous efficiency and luminescent lifetime of the light emitting layer 5.

Moreover, in the organic EL device 100 whose any layer of the organic compound layer 50 contains a phenylamine derivative (NPB, for instance) and aquinoline derivative (Alq, for instance), the weight concentration of sodium atoms contained in the organic layers 50 as impurities is preferably 2000 ppm or lower. This enhances the luminous efficiency and luminescent lifetime of the light emitting layer 5.

In an organic EL device in which at least one layer of the organic compound layer 50 contains a phenylamine derivative (NPB, for instance), and the weight of the above-mentioned at least one layer is 30% or higher of the weight of the organic compound layer 50, the weight concentration of copper atoms contained in the above-mentioned at least one layer as impurities is preferably 170 ppm or lower. This enhances the luminous efficiency and luminescent lifetime of the light emitting layer 5.

The weight concentration of copper atoms contained as impurities in the above-mentioned at least one layer is more preferably 70 ppm or lower. This further enhances the luminous efficiency and luminescent lifetime of the light emitting layer 5.

In an organic EL device in which at least one layer of the organic compound layer 50 contains a phenylamine derivative (NPB, for instance), and the weight of the above-mentioned at least one layer is 30% or higher of the weight of the organic compound layer 50, the weight concentration of aluminum atoms contained in the above-mentioned at least one layer as impurities is preferably 270 ppm or lower. This enhances the luminous efficiency and luminescent lifetime of the light emitting layer 5.

In an organic EL device in which at least one layer of the organic compound layer 50 contains a phenylamine derivative (NPB, for instance), and the weight of the above-mentioned at least one layer is 30% or higher of the weight of the organic compound layer 50, the weight concentration of iron atoms contained in the above-mentioned at least one layer as impurities is preferably 270 ppm or lower. This enhances the luminous efficiency and luminescent lifetime of the light emitting layer 5.

In an organic EL device in which at least one layer of the organic compound layer 50 contains a phenylamine derivative (NPB, for instance), and the weight of the above-mentioned at least one layer is 30% or higher of the weight of the organic compound layer 50, the weight concentration of nickel atoms contained in the above-mentioned at least one layer as impurities is preferably 300 ppm or lower. This enhances the luminous efficiency and luminescent lifetime of the light emitting layer 5.

In an organic EL device in which at least one layer of the organic compound layer 50 contains a phenylamine derivative (NPB, for instance), and the weight of the above-mentioned at least one layer is 30% or higher of the weight of the organic compound layer 50, the weight concentration of sodium atoms contained in the above-mentioned at least one layer as impurities is preferably 340 ppm or lower. This enhances the luminous efficiency and luminescent lifetime of the light emitting layer 5.

In an organic EL device in which at least one layer of the organic compound layer 50 contains a quinoline derivative (Alq, for instance), and the weight of the above-mentioned at least one layer is 30% or higher of the weight of the organic compound layer 50, the weight concentration of iron atoms contained in the above-mentioned at least one layer as impurities is preferably 270 ppm or lower. This enhances the luminous efficiency and luminescent lifetime of the light emitting layer 5.

In an organic EL device in which at least one layer of the organic compound layer 50 contains a quinoline derivative (Alq, for instance), and the weight of the above-mentioned at least one layer is 30% or higher of the weight of the organic compound layer 50, the weight concentration of nickel atoms contained in the above-mentioned at least one layer as impurities is preferably 300 ppm or lower. This enhances the luminous efficiency and luminescent lifetime of the light emitting layer 5.

In an organic EL device in which at least one layer of the organic compound layer 50 contains a quinoline derivative (Alq, for instance), and the weight of the above-mentioned at least one layer is 30% or higher of the weight of the organic compound layer 50, the weight concentration of sodium atoms contained in the above-mentioned at least one layer as impurities is preferably 340 ppm or lower. This enhances the luminous efficiency and luminescent lifetime of the light emitting layer 5.

While in the present embodiment, NPB and Alq are employed as organic compounds for each layer of the organic compound layer 50, metal complexes, such as iridium compound derivatives such as Tris(2-phenylpyridine)iridium (which may also be abbreviated as Ir(ppy)3), and platinum compound derivatives and copper phthalocyanine (CuPc) derivatives, may also be employed other than the organic compounds above. Note that the copper forming copper phthalocyanine is not included with the above-mentioned copper atoms as impurities.

Further, while in the present embodiment the organic EL device 100 has a structure in which the hole injection electrode 2, organic compound layer 50, and electron injection electrode 8 are layered in this order on the glass substrate 1, the organic EL device 100 may have an alternative structure in which the hole injection electrode 2, hole transport layer 4, light emitting layer 5, electron injection layer 7, and electron injection electrode 8 are layered in this order on the glass substrate 1.

### EXAMPLES

In the following Examples, organic El devices whose metal atoms of each type contained in organic compound layers have various weight concentrations were fabricated, and luminescent characteristics of each of the light emitting layers 5 were measured. Note that the ICP method according to the above-mentioned embodiment was used as a method for measuring the weight concentration of metal atoms.

Here, luminous efficiencies of the light emitting layers 5 at a current density of 20 mA/cm² were measured. In addition, the light emitting layers 5 were caused to continuously emit light at a constant current, and the time lengths during which the respective initial luminances of 1500 cd/cm² were decreased to half were measured as their luminescent lifetimes.

In the present Examples, organic EL devices were used each having a structure in which a hole injection electrode 2, a hole transport layer 4, a light emitting layer 5, an electron injection layer 7, and an electron injection electrode 8 were layered in this order on a glass substrate 1.

The hole injection electrode 2 is a metal compound made of ITO, and the hole transport layer 4 is made of NPB. In this case, the hole transport layer 4 corresponds to an organic compound film including a compound having a phenylamino group. Further, the light emitting layer 5 is made of Alq, and the electron injection layer 7 is made of lithium fluoride (LiF). The electron injection electrode 8 is made of aluminum. The hole transport layer 4 and the light emitting layer 5 are each 500 Å in thickness. In this case, the light emitting layer 5 corresponds to an organic compound film including a compound having a quinolinol group.

In the present Examples, a plurality of types of NPBs and Alqs having different impurity concentrations were prepared by varying the numbers of times that NPBs and Alqs were purified by sublimation during the preparation. Using these NPBs and Alqs, luminescent characteristics of the light emitting layers 5 were measured.

### Example 1

In Example 1, the weight concentrations of copper atoms contained in the respective hole transport layers 4 were measured, and the luminous efficiencies and luminescent lifetimes of the light emitting layers 5 in the organic EL devices having the measured weight concentrations were each measured.

In Example 1, eight types of organic EL devices were used in which the weight concentrations of copper atoms in the hole transport layers 4 were 40 ppm, 80 ppm, 100 ppm, 200 ppm, 500 ppm, 800 ppm, 1100 ppm, and 1500 ppm, respectively. The measurement results are given in Table 1.

TABLE 1

| copper atom content | luminous efficiency | luminescent |
|---|---|---|
| (ppm) | (cd/A) | lifetime (hr) |
| 1500 | 1.9 | 130 |
| 1100 | 2.0 | 150 |
| 800 | 2.9 | 170 |
| 500 | 3.3 | 350 |
| 200 | 3.9 | 400 |
| 100 | 4.0 | 400 |
| 80 | 4.0 | 415 |
| 40 | 4.1 | 420 |

As shown in Table 1, the luminous efficiencies (cd/cm²) increased as the weight concentrations (ppm) of copper atoms decreased. Also, the luminescent lifetimes (hr) increased as the weight concentrations (ppm) of copper atoms decreased.

The luminescent lifetimes, in particular, resulted in 350 hr or longer in the cases where the weight concentrations of copper atoms were 40 to 500 ppm, which were increased twice or more the cases where the weight concentrations of copper atoms were 800 to 1500 ppm. In addition, the luminescent lifetimes resulted in 400 hr or longer in the cases where the weight concentrations of copper atoms were 200 ppm or lower.

The results above show that the weight concentration of copper atoms contained in the hole transport layer 4 is preferably 500 ppm or lower. More preferably, the weight concentration of copper atoms contained in the hole transport layer 4 is 200 ppm or lower.

### Example 2

In Example 2, the weight concentrations of aluminum atoms contained in the respective hole transport layers 4 were measured, and the luminous efficiencies and luminescent lifetimes of the light emitting layers 5 in the organic EL devices having the measured weight concentrations were each measured.

FIG. 2 is a graph showing the results of luminous efficiencies in relation to the weight concentrations of aluminum atoms contained in the hole transport layers 4.

As shown in FIG. 2, when the weight concentrations of aluminum atoms were 800 ppm or lower, luminous efficiencies having 90% or higher of a maximum value (for 300 ppm) were ensured.

The results above show that the weight concentration of aluminum atoms contained in the hole transport layer 4 is preferably 800 ppm or lower.

### Example 3

In Example 3, the weight concentrations of sodium atoms contained in the respective hole transport layers 4 were measured, and the luminous efficiencies and luminescent lifetimes of the light emitting layers 5 in the organic EL devices having the measured weight concentrations were each measured.

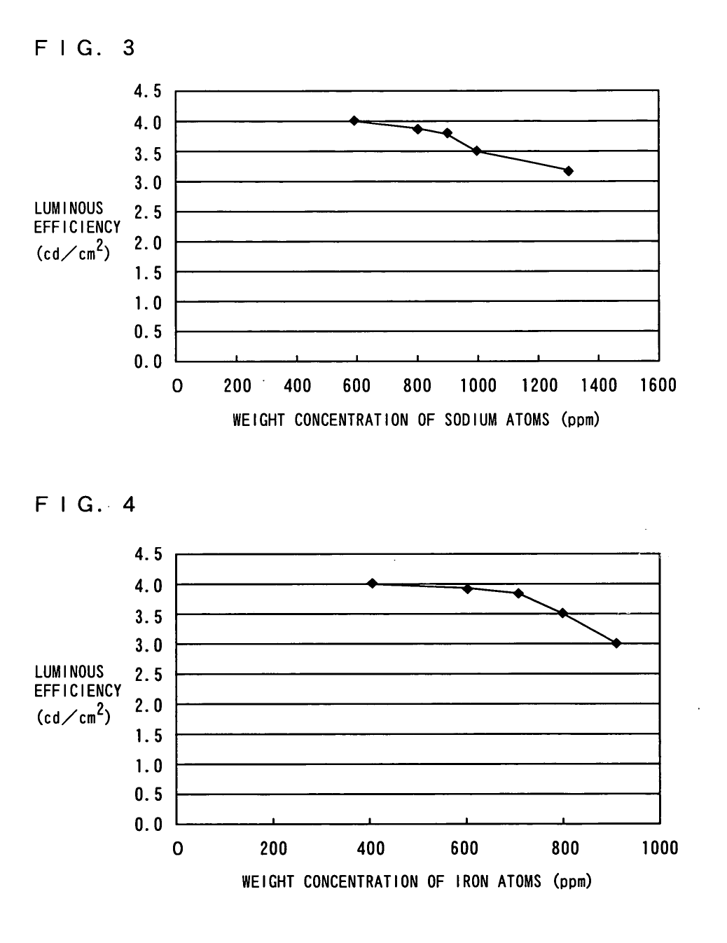

FIG. 3 is a graph showing the results of luminous efficiencies in relation to the weight concentrations of sodium atoms contained in the hole transport layers 4.

As shown in FIG. 3, when the weight concentrations of sodium atoms were 1000 ppm or lower, luminous efficiencies having 90% or higher of a maximum value (for 600 ppm) were ensured.

The results above show that the weight concentration of sodium atoms contained in the hole transport layer 4 is preferably 1000 ppm or lower.

### Example 4

In Example 4, the weight concentrations of iron atoms contained in the respective hole transport layers 4 were measured, and the luminous efficiencies and luminescent lifetimes of the light emitting layers 5 in the organic EL devices having the measured weight concentrations were each measured.

FIG. 4 is a graph showing the results of luminous efficiencies in relation to the weight concentrations of iron atoms contained in the hole transport layers 4.

As shown in FIG. 4, when the weight concentrations of iron atoms were 800 ppm or lower, luminous efficiencies having 90% or higher of a maximum value (for 400 ppm) were ensured.

The results above show that the weight concentration of iron atoms contained in the hole transport layer 4 is preferably 800 ppm or lower.

### Example 5

In Example 5, the weight concentrations of nickel atoms contained in the respective hole transport layers 4 were measured, and the luminous efficiencies and luminescent lifetimes of the light emitting layers 5 in the organic EL devices having the measured weight concentrations were each measured.

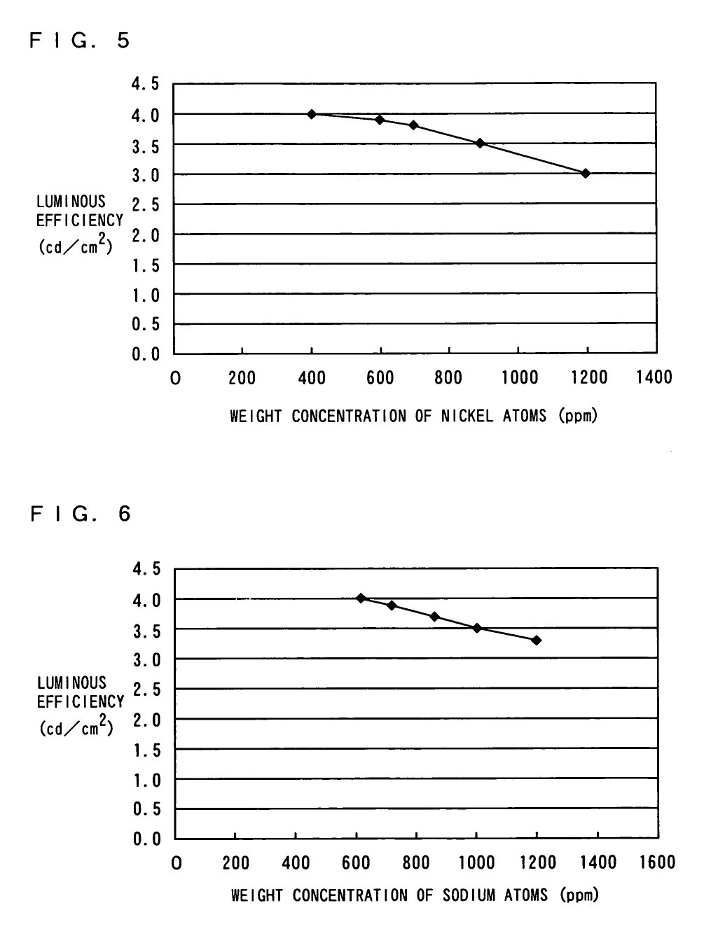

FIG. 5 is a graph showing the results of luminous efficiencies in relation to the weight concentrations of nickel atoms contained in the hole transport layers 4.

As shown in FIG. 5, when the weight concentrations of nickel atoms were 900 ppm or lower, luminous efficiencies having 90% or higher of a maximum value (for 400 ppm) were ensured.

The results above show that the weight concentration of nickel atoms contained in the hole transport layer 4 is preferably 900 ppm or lower.

### Example 6

In Example 6, the weight concentrations of sodium atoms contained in the respective light emitting layers 5 were measured, and the luminous efficiencies and luminescent lifetimes of the light emitting layers 5 in the organic EL devices having the weight concentrations were each measured.

FIG. 6 is a graph showing the results of luminous efficiencies for the weight concentrations of sodium atoms contained in the light emitting layers 5.

As shown in FIG. 6, when the weight concentrations of sodium atoms were 1000 ppm or lower, luminous efficiencies having 90% or higher of a maximum value (for 600 ppm) were ensured.

The results above show that the weight concentration of sodium atoms contained in the light emitting layer 5 is preferably 1000 ppm or lower.

### Example 7

In Example 7, the weight concentrations of iron atoms contained in the respective light emitting layers 5 were measured, and the luminous efficiencies and luminescent lifetimes of the light emitting layers 5 in the organic EL devices having the measured weight concentrations were each measured.

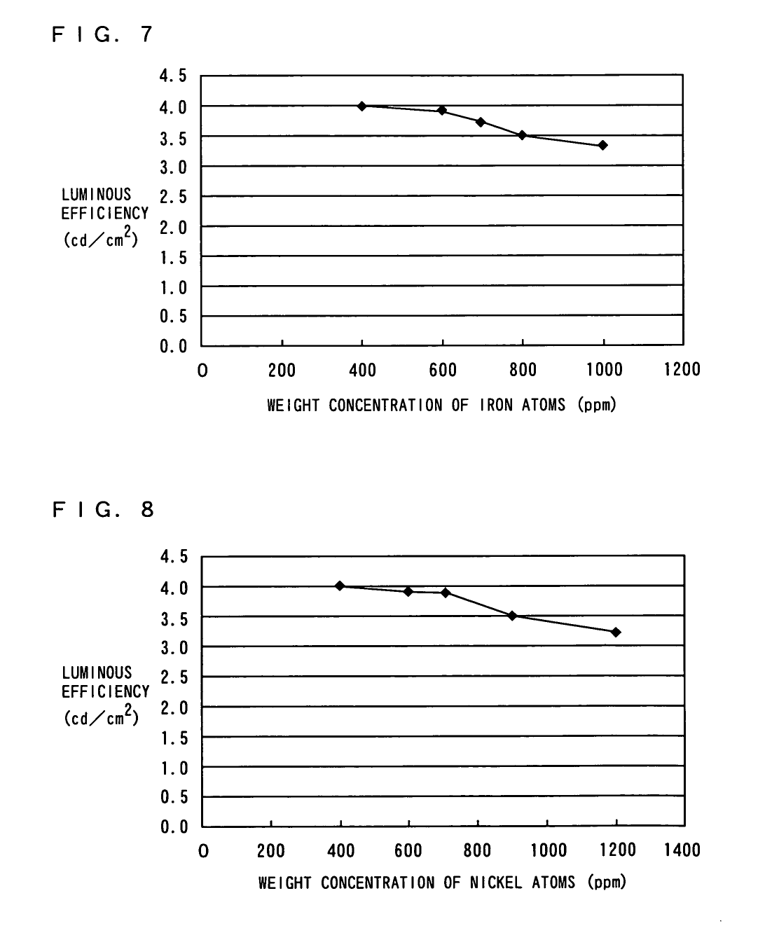

FIG. 7 is a graph showing the results of luminous efficiencies in relation to the weight concentrations of iron atoms contained in the light emitting layers 5.

As shown in FIG. 7, when the weight concentrations of iron atoms were 800 ppm or lower, luminous efficiencies having 90% or higher of a maximum value (for 400 ppm) were ensured.

The results above show that the weight concentration of iron atoms contained in the light emitting layer 5 is preferably 800 ppm or lower.

### Example 8

In Example 8, the weight concentrations of nickel atoms contained in the respective light emitting layers 5 were measured, and the luminous efficiencies and luminescent lifetimes of the light emitting layers 5 in the organic EL devices having the measured weight concentrations were each measured.

FIG. 8 is a graph showing the results of luminous efficiencies in relation to the weight concentrations of nickel atoms contained in the light emitting layers 5.

As shown in FIG. 8, when the weight concentrations of nickel atoms were 900 ppm or lower, luminous efficiencies having 90% or higher of a maximum value (for 400 ppm) were ensured.

The results above show that the weight concentration of nickel atoms contained in the light emitting layer 5 is preferably 900 ppm or lower.

Although the present invention has been described and illustrated in detail, it is clearly understood that the same is by way of illustration and example only and is not to be taken by way of limitation, the spirit and scope of the present invention being limited only by the terms of the appended claims.

1. An organic electroluminescent device comprising:
an organic compound layer including at least one organic compound film containing an organic compound having a phenylamino group, wherein
said organic compound layer contains copper atoms having a weight concentration of not higher than 500 ppm as impurities.

2. The organic electroluminescent device according to claim 1, wherein
said weight concentration of copper atoms as impurities in said organic compound layer is not higher than 200 ppm.

3. The organic electroluminescent device according to claim 1, wherein
said organic compound layer includes:
an organic compound film containing a luminescent material, and
an organic compound film containing a carrier transporting material.

4. An organic electroluminescent device comprising:
an organic compound layer including at least one organic compound film containing an organic compound having a phenylamino group, wherein
said organic compound layer contains aluminum atoms having a weight concentration of not higher than 800 ppm as impurities.

5. The organic electroluminescent device according to claim 4, wherein
said organic compound layer includes:
an organic compound film containing a luminescent material, and
an organic compound film containing a carrier transporting material.

6. An organic electroluminescent device comprising:
an organic compound layer including at least one organic compound film containing an organic compound having a phenylamino group, wherein
said organic compound layer contains iron atoms having a weight concentration of not higher than 800 ppm as impurities.

7. The organic electroluminescent device according to claim 6, wherein
said organic compound layer includes:
an organic compound film containing a luminescent material, and
an organic compound film containing a carrier transporting material.

8. An organic electroluminescent device comprising:
an organic compound layer including at least one organic compound film containing an organic compound having a phenylamino group, wherein
said organic compound layer contains nickel atoms having a weight concentration of not higher than 900 ppm as impurities.

9. The organic electroluminescent device according to claim 8, wherein
said organic compound layer includes:
an organic compound film containing a luminescent material, and
an organic compound film containing a carrier transporting material.

10. An organic electroluminescent device comprising:
an organic compound layer including at least one organic compound film containing an organic compound having a phenylamino group, wherein
said organic compound layer contains sodium atoms having a weight concentration of not higher than 1000 ppm as impurities.

11. The organic electroluminescent device according to claim 10, wherein
said organic compound layer includes:
an organic compound film containing a luminescent material, and
an organic compound film containing a carrier transporting material.

12. An organic electroluminescent device comprising:
an organic compound layer including at least one organic compound film containing an organic compound having a quinolinol group, wherein
said organic compound layer contains iron atoms having a weight concentration of not higher than 800 ppm as impurities.

13. The organic electroluminescent device according to claim 12, wherein
said organic compound layer includes:
an organic compound film containing a luminescent material, and
an organic compound film containing a carrier transporting material.

14. An organic electroluminescent device comprising:
an organic compound layer including at least one organic compound film containing an organic compound having a quinolinol group, wherein
said organic compound layer contains nickel atoms having a weight concentration of not higher than 900 ppm as impurities.

15. The organic electroluminescent device according to claim 14, wherein
said organic compound layer includes:
an organic compound film containing a luminescent material, and
an organic compound film containing a carrier transporting material.

16. An organic electroluminescent device comprising:
an organic compound layer including at least one organic compound film containing an organic compound having a quinolinol group, wherein
said organic compound layer contains sodium atoms having a weight concentration of not higher than 1000 ppm as impurities.

17. The organic electroluminescent device according to claim 16, wherein
said organic compound layer includes:
an organic compound film containing a luminescent material, and
an organic compound film containing a carrier transporting material.
